(19) United States
(12) Patent Application Publication
(10) Pub. No.: US 2006/0272770 A1
(43) Pub. Date: Dec. 7, 2006

(54) Method for making artificial leather with superficial texture

(75) Inventors: Mao-Kan Lee, Liujiao Shiang (TW); Ming-Cheng Chang, Sanmin (TW); Zhing-Hung Chen, Qianzhen (TW); Yung-Hsiang Chou, Pingtung County (TW)

Correspondence Address: NIKOLAI & MERSEREAU, P.A., 900 SECOND AVENUE SOUTH, SUITE 820, MINNEAPOLIS, MN, 55402, US

(73) Assignee: SAN FANG CHEMICAL INDUSTRY CO., LTD., Jenwu Shiang (TW)

(21) Appl. No.: 11/505,009

(22) Filed: Aug. 16, 2006

Related U.S. Application Data
(63) Continuation-in-part of application No. 11/270,436, filed on Nov. 9, 2005.
Application No. 11/270,436 is a continuation-in-part of application No. 11/199,437, filed on Aug. 8, 2005.

(30) Foreign Application Priority Data
Jan. 19, 2005 (TW) 094101604
Aug. 16, 2005 (TW) 094127886
Aug. 24, 2004 (TW) 093125412

(51) Int. Cl. B65C 9/25; B32B 37/00

(52) U.S. Cl. 156/322; 156/358

(57) ABSTRACT

Disclosed is a method for making artificial leather with superficial texture. In the method, a substrate is coated, in a non-overall manner, with a wet polyurethane resin. After curing, there is provided a polyurethane resin coated on releasing paper. Thus, a semi-product is made. Texture of the releasing paper is transferred to a surface of the semi-product. Then, the semi-product with the texture on the surface is coated with a layer of a chemical. A machine is used to heat and flatten the surface of the semi-product. Finally, the semi-product is physically finished by forces so that the surface of the final product is formed with texture like that of real leather.

### CROSS-REFERENCE TO RELATED APPLICATIONS

The present application is a continuation-in-part application of U.S. patent application Ser. No. 11/270,436 filed Nov. 9, 2005, which is a continuation-in-part application of U.S. patent application Ser. No. 11/199,437 filed Aug. 8, 2005.

### BACKGROUND OF INVENTION

1. Field of Invention The present invention relates to a method for making artificial leather with superficial texture and, more particularly, to artificial leather made by a special attaching manner and a surface-processing method so that the artificial leather is made with texture and provides soft, comfortable touch like real leather.

2. Related Prior Art

A conventional method for making artificial leather includes two processes, a dry process and a wet process. The dry process includes two steps. Firstly, releasing paper is coated with a layer of a dry polyurethane resin with thickness of 0.01 to 0.10 mm. Secondly, the dry polyurethane resin layer is coated with an adhesive polyurethane resin (“paste”) for forming an adhesive layer with thickness of 0.01 to 0.08 mm. The wet process includes four steps. Firstly, a substrate is submerged in a polyurethane resin so that a submersion layer is formed in the substrate. Secondly, the substrate is coated with a coating polyurethane resin. Thirdly, the substrate and the layers are cured, washed and subject to other wet processing for forming a foam layer on the substrate. Fourthly, the adhesive layer the laminate resulting from the dry process is attached to the foam layer of the laminate resulting from the wet process. The releasing paper is removed to provide artificial that looks and feels like real leather.

In the adhesion, the adhesive layer is formed by providing the paste in an overall manner. This coating however makes the artificial leather hard and feel like plastic instead of real leather. Moreover, since the releasing paper is formed with texture by continuous printing, the texture of the artificial leather reprinted from the texture of the releasing paper is not irregular and vivid as with real leather. Hence, artificial leather is not accepted by the public.

The present invention is therefore intended to obviate or at least alleviate the problems encountered in prior art.

### SUMMARY OF INVENTION

It is the primary objective of the present invention to provide a method for making artificial leather that is soft and flexible and includes vivid texture.

To achieve the primary objective, the method includes the step of coating a substrate with a porous wet polyurethane resin film by providing paste in a non-overall manner. After curing, a polyurethane resin coated on releasing paper is attached to the wet polyurethane resin film, and texture of the releasing paper is imprinted thereon. Then, surface-processing is done by coating a layer of chemical on a semi-product with texture. A machine is used to iron the semi-product. Forces are used to provide a final product of the artificial leather that is soft and flexible and includes vivid texture.

In the step of providing the paste, the non-overall manner is a gap, disconnected, an irregular manner, a regular manner, a gravure, an letterpress or a spotted manner. The area of the coating of the paste is 10% to 90% of the total area. The coating is hollow. After subject to the forces, the fibers of the substrate become fluffy and the final product is elastic and soft like real leather.

The chemical may be a polyurethane resin, a polyester resin, a PU resin, a silicon-containing chemical and a wax-containing chemical. The ironing is conducted at a temperature of 20 to 300 degrees Celsius.

The forces may be exerted by throwing the semi-product onto an external object, throwing an external object onto the semi-product or throwing the semi-product onto another semi-product. The forces may be exerted by a solid object, a pressurized air jet or a pressurized water jet and scrubbing. Alternatively, the forces may be exerted by vibration in all directions, pressurized high-speed pumping and throwing or free falling. Moreover, air or liquid can be used to exert the forces to make the fibers of the substrate fluffy so that the final product is elastic and soft like real leather and that the texture of the final product made by the releasing paper is irregular and vivid.

Other objectives, advantages and features of the present invention will become apparent from the following description referring to the attached drawings.

### BRIEF DESCRIPTION OF DRAWINGS

The present invention will be described through detailed illustration of three embodiments referring to the drawings.

FIG. 1 is a cross-sectional view of artificial leather including a substrate according to the present invention.

FIG. 2 is a cross-sectional view of the artificial leather shown in FIG. 1 wherein the substrate is made of ultra-fine fibers.

FIG. 3 is a cross-sectional view of the artificial leather shown in FIG. 1 wherein the substrate is a woven or non-woven fabric.

FIG. 4 is a cross-sectional view of the artificial leather shown in FIG. 1 wherein the substrate includes an ultra-fine fiber layer and a woven or non-woven fabric.

### DETAILED DESCRIPTION OF EMBODIMENTS

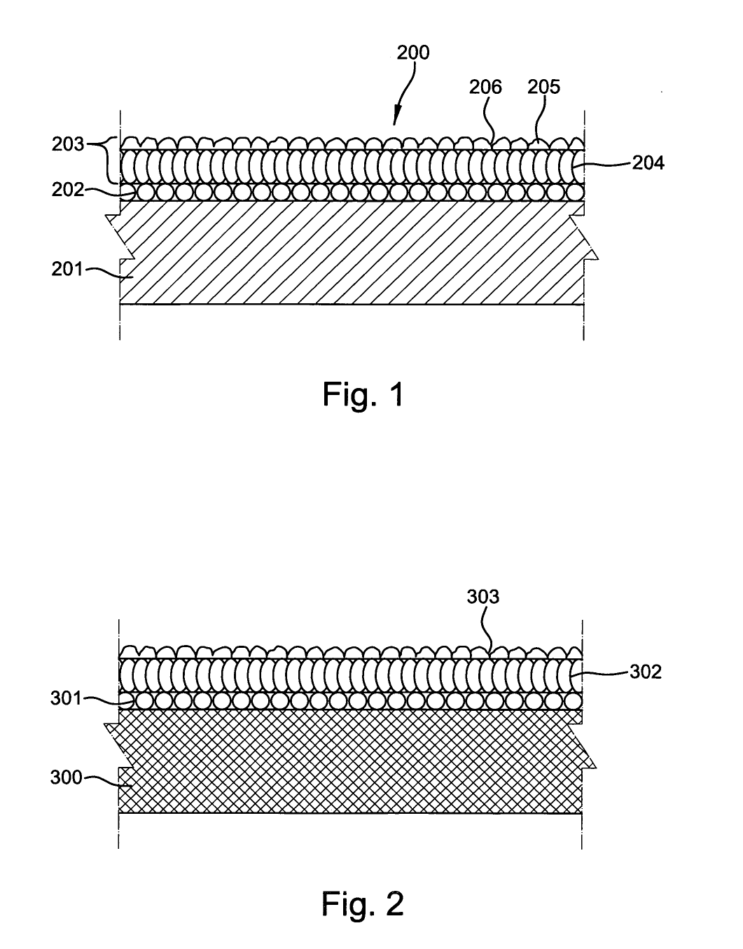

Referring to FIG. 1, there is shown artificial leather 200 according to the present invention. The artificial leather 200 includes a substrate 201 and a composite layer 203 coated on the substrate 201. The substrate 201 may be a woven fabric, a non-woven fabric, an ultra-fine fiber layer or any combination thereof. The composite layer 203 includes a wet polyurethane resin film 204 and a polyurethane resin layer 205. The wet polyurethane resin film 204 includes a porous structure. The polyurethane resin layer 205 is coated on releasing paper and attached to the polyurethane resin film 204 and subject to surface-processing. The polyurethane resin layer 205 includes texture 206 reprinted from the releasing paper.

To make the artificial leather 200, the substrate 201 is coated with paste in a non-overall manner to form an adhesive layer 202 for attaching the wet polyurethane film 204 to the substrate 201. A polyurethane resin is coated on the releasing paper. The releasing paper is formed with texture and attached to the wet polyurethane film 204 with the porous structure. After removing the releasing paper, there is provided a semi-product of the artificial leather 200 with the texture 206 on the surface. The texture 206 of the semi-product of the artificial leather 200 is coated with a chemical at a quantity of 10 to 200 g/m² printing or spraying, dried and ironed at a temperature of 20 to 200 degrees Celsius by a wheel. A drawback of a dry surface is overcome so that the artificial leather 200 provides comfortable touch and a shinning look like real leather. Then, irregular forces are exerted on the texture 206 of the semi-product of the artificial leather 200 for twisting the texture 206 so that the texture 206 is irregular and vivid like that of real leather.

Referring to FIG. 2, the substrate is an ultra-fine fiber layer 300 with thickness of 0.2 to 4.0 mm. There is provided an adhesive layer 301 in a dotted non-overall manner at a quantity of 10 to 300 g/m² for attaching a wet polyurethane resin film 302 with a porous structure and thickness of 0.1 to 1.0 mm. After curing, an ultra-fine fiber semi-product is made. On the other hand, releasing paper is coated with a polyurethane resin at a quantity of 10 to 500 g/m². The polyurethane resin layer is attached to the ultra-fine fiber semi-product. After removing the releasing paper, a semi-product of the artificial leather is provided with texture. The texture of the semi-product of the artificial leather is coated with a chemical at a quantity of 10 to 200 g/m² by printing or spraying, dried and ironed at a temperature of 20 to 300 degrees Celsius by a wheel. A drawback of a dry surface is overcome so that the artificial leather provides comfortable touch and a shinning look like real leather. Then, the semi-product of the artificial leather is thrown and scrubbed for example to provide irregular and vivid texture 303 like that of real leather.

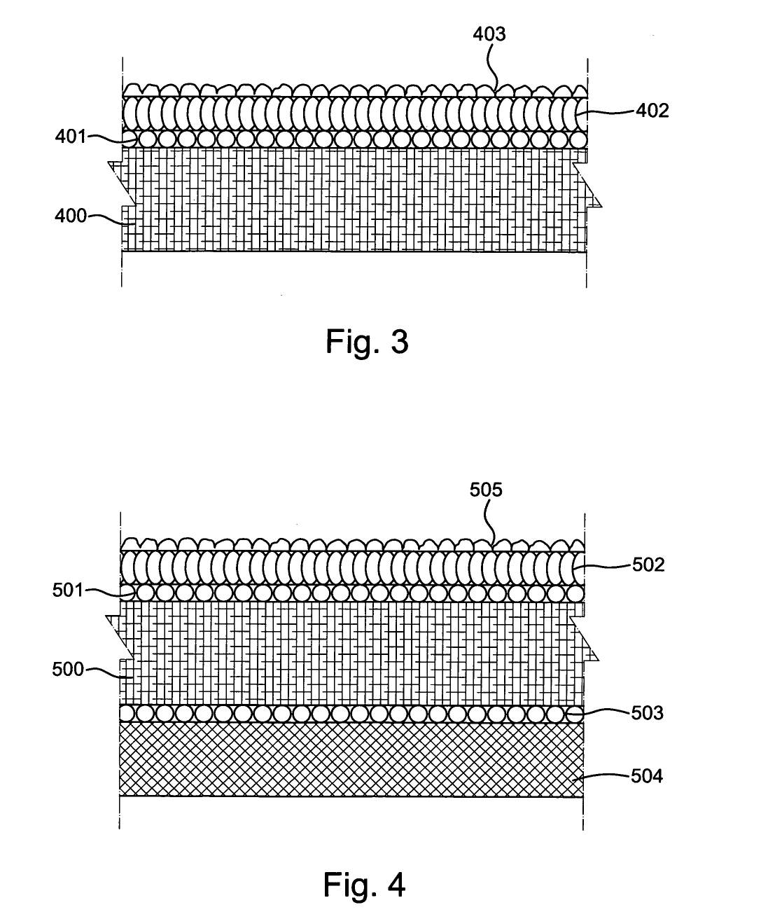

Referring to FIG. 3, there is provided a substrate 400 that is a woven fabric with thickness of 0.1 to 2.0 mm or a non-woven fabric with thickness of 0.2 to 4.0 mm. There is provided an adhesive layer 401 in a dotted non-overall manner at a quantity of 10 to 300 g/m² for attaching a wet polyurethane resin film 402 with a porous structure and thickness of 0.1 to 1.0 mm. After curing, a woven or non-woven fabric semi-product is made. On the other hand, releasing paper is coated with a polyurethane resin at a quantity of 10 to 500 g/m². The polyurethane resin layer is attached to the ultra-fine fiber semi-product. After removing the releasing paper, a semi-product of the artificial leather is provided with texture. The texture of the semi-product of the artificial leather is coated with a chemical at a quantity of 10 to 200 g/m² by printing or spraying, dried and ironed at a temperature of 20 to 300 degrees Celsius by a wheel. A drawback of a dry surface is overcome so that the artificial leather provides comfortable touch and a shinning look like real leather. Then, the semi-product of the artificial leather is thrown and scrubbed for example to provide irregular and vivid texture 403 like that of real leather.

Referring to FIG. 4, there is provided a substrate 500 that is a woven fabric with thickness of 0.1 to 2.0 mm or a non-woven fabric with thickness of 0.2 to 4.0 mm. There is provided a first adhesive layer 501 in a dotted non-overall manner at a quantity of 10 to 300 g/m² for attaching a wet polyurethane resin film 502 with a porous structure and thickness of 0.1 to 1.0 mm. After curing, a woven or non-woven fabric semi-product is made. On the other hand, there is provided a second adhesive layer 503 in a dotted non-overall manner for attaching an ultra-fine fiber layer 504 for providing an ultra-fine fiber semi-product. Releasing paper is coated with a polyurethane resin at a quantity of 10 to 500 g/m². The polyurethane resin layer is attached to the ultra-fine fiber semi-product. After removing the releasing paper, a semi-product of the artificial leather is provided with texture. The texture of the semi-product of the artificial leather is coated with a chemical at a quantity of 10 to 200 g/m² by printing or spraying, dried and ironed at a temperature of 20 to 300 degrees Celsius by a wheel. A drawback of a dry surface is overcome so that the artificial leather provides comfortable touch and a shinning look like real leather. Then, the semi-product of the artificial leather is thrown and scrubbed for example to provide irregular and vivid texture 505 like that of real leather.

Sample 1

An ultra-fine fiber sheet that is 1.1 mm thick is coated with a porous polyurethane film that is 0.4 mm thick at a quantity of 10 to 500 g/m² in a dotted non-overall manner. Releasing paper is coated with a dry polyurethane resin at a quantity of 300 g/m², and dried and attached so that texture of the releasing paper is reprinted onto the ultra-fine fiber semi-product. Surface-processing is done by providing a polyurethane chemical at a quantity of 50 g/m². Ironing is done by a wheel at a temperature of 90 degrees Celsius. Thus, the artificial leather provides a look and touch like real leather. The artificial leather is thrown and scrubbed so that texture of the artificial leather is twisted and becomes irregular and vivid like that of real leather.

Sample 2

A woven fabric that is 0.7 mm thick is coated with a porous polyurethane film that is 0.4 mm thick at a quantity of 10 to 500 g/m² in a dotted non-overall manner. Releasing paper is coated with a dry polyurethane resin at a quantity of 300 g/m², and dried and attached so that texture of the releasing paper is reprinted onto the ultra-fine fiber semi-product. Surface-processing is done by providing a polyurethane chemical at a quantity of 50 g/m². Ironing is done by a wheel at a temperature of 90 degrees Celsius. Thus, the artificial leather provides a look and touch like real leather. The artificial leather is thrown and scrubbed so that texture of the artificial leather is twisted and becomes irregular and vivid like that of real leather.

Sample 3

A non-woven fabric that is 0.9 mm thick is coated with a porous polyurethane film that is 0.4 mm thick at a quantity of 80 g/m² in a spotted non-overall manner. Releasing paper is coated with a dry polyurethane resin at a quantity of 300 g/m², and dried and attached so that texture of the releasing paper is reprinted onto the ultra-fine fiber semi-product. Surface-processing is done by providing a polyurethane chemical at a quantity of 60 g/m². Ironing is done by a wheel at a temperature of 90 degrees Celsius. Thus, the artificial leather provides a look and touch like that of real leather. The artificial leather is thrown and scrubbed so that texture of the artificial leather is twisted and becomes irregular and vivid like that of real leather.

Sample 4

A woven fabric that is of 0.7 mm thick is coated with a porous polyurethane film that is 0.4 mm thick at a quantity of 80 g/m² in a spotted non-overall manner. After curing, a woven fabric semi-product is made.

An ultra-fine fiber sheet that is 1.1 mm thick is attached to the woven fabric semi-product by an adhesive layer provided in a dotted non-overall manner at a quantity of 80 g/m². Releasing paper is coated with a dry polyurethane resin at a quantity of 300 g/m², and dried and attached so that texture of the releasing paper is reprinted onto the ultra-fine fiber sheet.

Surface-processing is done by providing a polyurethane chemical at a quantity of 50 g/m². Ironing is done by a wheel at a temperature of 90 degrees Celsius. Thus, the artificial leather is provided with a look and touch like real leather. The artificial leather is thrown and scrubbed so that texture of the artificial leather is twisted and becomes irregular and vivid like that of real leather.

Sample 5

A non-woven fabric that is 0.7 mm thick is coated with a porous polyurethane film that is 0.4 mm thick at a quantity of 80 g/m². After curing, a non-woven fabric semi-product is made. An ultra-fine fiber sheet that is 1.1 mm thick is attached to the non-woven fabric semi-product by an adhesive layer provided at a quantity of 80 g/m² in a spotted non-overall manner. Releasing paper is coated with a dry polyurethane resin at a quantity of 300 g/m², and dried and attached so that texture of the releasing paper is reprinted onto the ultra-fine fiber semi-product. Surface-processing is done by providing a polyurethane chemical at a quantity of 50 g/m². Ironing is done by a wheel at a temperature of 90 degrees Celsius. Thus, the artificial leather provides a look and touch like real leather. The artificial leather is thrown and scrubbed so that texture of the artificial leather is twisted and becomes irregular and vivid like that of real leather.

The samples have been compared with conventional artificial leather, and results have been listed in TABLE 1 as follows.

TABLE 1

| | Ruling | | | | | | |
|---|---|---|---|---|---|---|---|
| | Method | Prior Art | Sample 1 | Sample 2 | Sample 3 | Sample 4 | Sample 5 |
| Texture | | Plastic | | | | Grain of | Grain of pig |
| Type | | Leather | Grain of cattle skin | | | sheep skin | skin |
| Thickness | ASTM | 1.3 +− 0.1 | 1.6 +− 0.1 | 1.2 +− 0.1 | 1.4 +− 0.1 | 1.2 +− 0.1 | 1.2 +− 0.1 |
| (mm) | D1777 | | | | | | |
| Weight | ASTM | 630 +− 50 | 550 +− 30 | 500 +− 30 | 530 +− 30 | 500 +− 30 | 500 +− 30 |
| (g/m²) | D3776 | | | | | | |
| Touch | ASTM | 0.18 to 0.22 | 0.30 to 0.34 | 0.28 to 0.31 | 0.30 to 0.34 | 0.29 to 0.32 | 0.28 to 0.32 |
| (Frictional | D1894 | | | | | | |
| Coefficient) | | | | | | | |
| Hardness | ST 300 | 2.3 to 2.5 | 4.3 to 4.5 | 4.7 to 4.8 | 4.5 to 4.7 | 4.7 to 4.8 | 4.6 to 4.8 |
| Texture | | 0.05 to 0.1 | 0.01 to 0.02 | 0.01 to 0.02 | 0.01 to 0.02 | 0.01 to 0.02 | 0.01 to 0.02 |
| Fineness | | | | | | | |
| (mm) | | | | | | | |
| Flexibility | DIN53351 | 50,000 | 100,000 | 100,000 | 100,000 | 100,000 | 100,000 |
| Abrasion | ASTM | 1000 | 2000 | 1200 | 1600 | 1250 | 1240 |
| Durability | D3884 | | | | | | |
| (Sandpaper | | | | | | | |
| #320) | | | | | | | |
| Leather | | 0 | 10 | 8 | 10 | 8 | 8 |
| comparison | | | | | | | |
| index | | | | | | | |

The leather comparison index is given according the surface status and the touch, wherein “0” means the surface status and the touch are both bad, “5” means the surface status or the touch is bad, and “10” means that the surface status and the touch are both good.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A method for making artificial leather with texture, the method comprising the steps of:
coating a substrate with a porous wet polyurethane resin film by providing paste in a non-overall manner;
coating a polyurethane resin on releasing paper that includes texture, and attaching the polyurethane resin to the wet polyurethane resin film, and removing the releasing paper for making a semi-product of the artificial leather with texture;
conducting surface-processing by providing a chemical on the texture of the semi-product;
ironing the semi-product; and
exerting forces on the semi-product.

2. The method according to claim 1 wherein the non-overall manner is a gap, disconnected, an irregular manner, a regular manner, a gravure, an letterpress or a spotted manner so that the area of the coating of the paste is 10% to 90% of the total area.

3. The method according to claim 1 wherein the chemical is selected from a group consisting of a polyurethane resin, a polyester resin, a PU resin, a silicon-containing chemical and a wax-containing chemical.

4. The method according to claim 1 wherein the chemical is provided in a gap or by rolling or spraying.

5. The method according to claim 1 wherein the ironing is conducted at a temperature of 20 to 300 degrees Celsius.

6. The method according to claim 1 wherein the forces are exerted by throwing the semi-product on an external object, throwing an external object onto the semi-product or throwing the semi-product onto another semi-product.

7. The method according to claim 6 wherein the forces are exerted by a solid object, a pressurized air jet or a pressurized water jet and scrubbing.

8. The method according to claim 6 wherein the forces are exerted by vibration in all directions, pressurized high-speed pumping and throwing or free falling.
